(19) United States
(12) Patent Application Publication
(10) Pub. No.: US 2020/0307919 A1
(43) Pub. Date: Oct. 1, 2020

(54) ITEM CONVEYING APPARATUS FOR A MATERIAL HANDLING ENVIRONMENT

(71) Applicant: TRANSNORM SYSTEM GMBH, Harsum (DE)

(72) Inventor: Ingo Mesterheide, Harsum (DE)

(21) Appl. No.: 16/804,925

(22) Filed: Feb. 28, 2020

Related U.S. Application Data
(60) Provisional application No. 62/826,202, filed on Mar. 29, 2019.

(51) Int. Cl. B65G 37/00; B66F 7/06; B65G 41/00; B65G 67/02; B65G 21/12; B65G 21/14; B65G 13/12; B65G 47/76; B60P 1/36

(52) U.S. Cl. CPC B65G 37/005; B66F 7/065; B65G 41/003; B65G 67/02; B60P 1/36; B65G 21/14; B65G 13/12; B65G 47/76; B65G 21/12

(57) ABSTRACT

Various example embodiments described herein relate to an item conveying apparatus. The item conveying apparatus can include a lift device suspended from a ceiling. Further, the item conveying apparatus can include a conveyor. The conveyor can be at least partially engaged with the lift device. The lift device can cause manipulation of a position of the conveyor. Further, the conveyor can include a conveyor frame and multiple conveyor segments. The multiple conveyor segments can define a conveying surface for conveying an item. In this aspect, in an example, at least one conveyor segment can be adapted to (a) extend outwards from the conveyor frame to move the conveyor into an operational position and (b) retract, inwards within the conveyor frame to move the conveyor into a parking position.

### CROSS REFERENCE TO RELATED APPLICATIONS

The present application is a non-provisional conversion application of and claims the benefit of priority to U.S. Provisional Patent Application No. 62/826,202, entitled “Boom Conveyor for Material Handling System,” filed on 29 Mar. 2019, the entirety of which is hereby incorporated by reference.

### TECHNOLOGICAL FIELD

Example embodiments described herein relate generally to an item conveying apparatus for a material handling environment, and, more particularly, to a lift device and a conveyor of the item conveying apparatus.

### BACKGROUND

Generally, in material handling environments like, but not limited to, distribution centers, warehouses, inventories, or shipping centers, various machines such as, conveyors, palletizers, robotic arms, truck loaders/unloaders, and/or conveyor overhead units are used for performing various operations. To achieve lower overhead costs at retail stores, now-a-days, in-store product counts at distribution centers have been reduced and products-in-transit on vehicles like, trucks, trailers etc. are also counted as part of available store stock of an inventory. Typically, in the material handling environments, vehicles can be loaded using manual labor if the containers are separate articles or can be loaded/unloaded using forklifts if the containers are palletized, or often by using other truck loader/unloader units. Using human laborers to unload and load large vehicle shipments can be physically difficult and can be costly due to the time and labor involved.

### SUMMARY

The following presents a simplified summary to provide a basic understanding of some aspects of the disclosed material handling system. This summary is not an extensive overview and is intended to neither identify key or critical elements nor delineate the scope of such elements. Its purpose is to present some concepts of the described features in a simplified form as a prelude to the more detailed description that is presented later.

Various example embodiments described herein relate to an item conveying apparatus. The item conveying apparatus can include a lift device suspended from a ceiling. Further, the item conveying apparatus can include a conveyor. The conveyor can be at least partially engaged with the lift device. The lift device can be configured to manipulate a positioning of the conveyor. Further, the conveyor can include a conveyor frame and a plurality of conveyor segments. The plurality of conveyor segments can define a conveying surface for conveying an item. In this aspect, in an example, at least one conveyor segment of the plurality of conveyor segments can be adapted to (a) extend outwards from the conveyor frame to move the conveyor into an operational position and (b) retract, inwards within the conveyor frame to move the conveyor into a parking position.

In an example embodiment, the lift device of the item conveying apparatus can be an inverted scissor lift.

In an example embodiment, the lift device can comprise at least two actuator elements adapted to lower an actuation platform of the lift device to lower a height of the conveyor relative to a ground plane. The actuation platform can be coupled to a conveyor segment of the conveyor. Further, in an example, the at least two actuator elements can be adapted to raise the actuation platform of the lift device to raise a height of the conveyor relative to the ground plane.

According to an example embodiment, the conveyor of the item conveying apparatus can be a roller conveyor defined between two side rails of the conveyor frame.

In an example embodiment, the conveyor can be adapted to be moved to one of: the parking position, a retracted position, and the operational position. In the operational position, the plurality of conveyor segments of the conveyor can be extended outwards from the conveyor frame. Further, in a retracted position, the plurality of conveyor segments of the conveyor can be partially retracted within the conveyor frame. Furthermore, in the parking position, the plurality of conveyor segments of the conveyor can be at least partially retracted within the conveyor frame and the conveyor can be raised up by the lift device towards the ceiling at a parking height.

According to an example embodiment, the conveyor of the item conveying apparatus can be installed above an in-feed conveyor of a material handling environment. In this regard, one end of the conveyor can extend to define an inclined path adapted to drop a first item from the conveyor onto a first conveying surface of the in-feed conveyor.

According to another example embodiment, the conveyor of the item conveying apparatus can be installed below an out-feed conveyor. In this regard, one end of the out-feed conveyor can extend to define an inclined path adapted to, drop a second item from a second conveying surface of the out-feed conveyor onto the conveyor.

In one example embodiment, the conveyor of the item conveying apparatus can be coupled to an item handling unit. The item handling unit can include an item transfer section and a sectional floor unit. In an example, at least a portion of the item transfer section can be engaged to the lift device. Further, the sectional floor unit can be coupled to the item transfer section. Furthermore, the sectional floor unit can include a transfer flap and a sectional floor garage. The transfer flap can be coupled to an end of the conveyor. Furthermore, the transfer flap can be configured to interface with a portion of the item carriage section of the vehicle. Furthermore, the sectional floor garage can be defined beneath the conveyor and can be configured to receive a sectional floor surface of the vehicle.

According to an example embodiment, the sectional floor unit of the item handling unit can be coupled to the item carriage section of the vehicle. The coupling of the sectional floor unit with the item carriage section can be based on (a) an interfacing of the transfer flap with the portion of the item carriage section and (b) a connection of a first drive cable of the sectional floor unit to a second drive cable of the item carriage section. In an example, at least one of the first drive cable and the second drive cable can be configured to slidably pull the sectional floor surface of the vehicle into the sectional floor garage.

According to an example embodiment, a system comprising a conveyor suspended from a ceiling is described. The conveyor can include a conveyor frame and a plurality of conveyor segments. The plurality of conveyor segments can be adapted to move relative to the conveyor frame. The plurality of conveyor segments can define a conveying surface for an item. In an example, upon receiving a command from a control unit, at least one conveyor segment of the plurality of the conveyor segments can be adapted to (a) extend outwards from the conveyor frame and (b) retract inwards within the conveyor frame.

In an example embodiment, the lift device can be suspended from the ceiling. Further, the conveyor can be at least partially engaged with the lift device. In an example embodiment, the lift device can be an inverted scissor lift.

According to one example embodiment, the lift device can comprise at least two actuator elements. The at least two actuator elements can be adapted to lower an actuation platform of the lift device to lower a height of the conveyor relative to a ground plane. In this regard, the actuation platform can be coupled to a conveyor segment of the conveyor. Further, the at least two actuator elements of the lift device can be adapted to raise the actuation platform to raise a height of the conveyor relative to the ground plane.

In an example embodiment, the conveyor can be a roller conveyor defined between two side rails of the conveyor frame. In this regard, in an example embodiment, the roller conveyor can comprise a plurality of drive wheel assemblies positioned within side rails defined by the conveyor frame. Further, the drive wheel assemblies can be adapted to move at the least one conveyor segment of the plurality of conveyor segments relative to the conveyor frame.

In an example embodiment, the conveyor can be adapted to be moved to one of: the parking position, a retracted position, and the operational position. In the operational position, the plurality of conveyor segments of the conveyor can be extended outwards from the conveyor frame. Further, in a retracted position, the plurality of conveyor segments of the conveyor can be partially retracted within the conveyor frame. Furthermore, in the parking position, the plurality of conveyor segments of the conveyor can be at least partially retracted within the conveyor frame.

Some example embodiments described herein relate to a method for handling items in a material handling environment. The method can include actuating a lift device to position a conveyor at a predetermined height relative to an item carriage section of a transport carrier. The conveyor can be coupled to the lift device and can be suspended from a ceiling. Further, the method can include extending at least one segment of the conveyor outwards to position the conveyor in an operating position. Upon positioning the conveyor in the operating position, the method can include, signaling one of: (i) an outflow of a first item by transferring the first item from a source conveyor to the conveyor or (ii) an inflow of a second item by transferring the second item from the conveyor to the source conveyor. Furthermore, the method can include retracting, the at least one conveyor segment of the conveyor to position the conveyor in a parking position.

In an example embodiment, the conveyor can be coupled to an item handling unit. In this regard, the method can further include interfacing a sectional floor unit of the item handling unit with the item carriage section of the transport carrier. Furthermore, the method can include receiving a sectional floor surface of the item carriage section of the transport carrier into a sectional floor garage defined beneath the conveyor to unload a plurality of items from the transport carrier onto the conveyor of the item handling unit.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 schematically illustrates a first side-view representing an item conveying apparatus in a first state, in accordance with various example embodiments described herein;

FIG. 2 schematically illustrates a second side-view representing the item conveying apparatus in a second state, in accordance with various example embodiments described herein;

FIG. 3 schematically illustrates a third side-view representing the item conveying apparatus in a third state, in accordance with various example embodiments described herein;

FIG. 4 schematically illustrates a first top view of the item conveying apparatus in a first operational state, in accordance with some example embodiments described herein;

FIG. 5 schematically illustrates a second top view of the item conveying apparatus in a second operational state, in accordance with some example embodiments described herein;

FIG. 6 schematically illustrates a third top view of the item conveying apparatus in a third operational state, in accordance with some example embodiments described herein;

FIG. 7 schematically illustrates an item handling unit of the item conveying apparatus in a first operating state, in accordance with some example embodiments described herein;

FIG. 8 schematically illustrates the item handling unit of the item conveying apparatus in a second operating state, in accordance with some example embodiments described herein;

FIG. 9 schematically illustrates the item handling unit of the item conveying apparatus in a third operating state, in accordance with some example embodiments described herein;

FIG. 10 schematically illustrates the item handling unit of the item conveying apparatus in a fourth operating state, in accordance with some example embodiments described herein;

FIG. 11 schematically illustrates a side view of a sectional floor unit of the item handling unit of the item conveying apparatus, in accordance with some example embodiments described herein;

FIG. 12 schematically illustrates an example flowchart depicting operations performed by the item conveying apparatus, in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout. Terminology used in this patent is not meant to be limiting insofar as devices described herein, or portions thereof, may be attached or utilized in other orientations.

The phrases “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term ‘distribution center’ or ‘material handling environment’ refers to an environment related to, but not limited to, manufacturing of the items, inventory storage of the items, packaging and unpackaging of the items, preparing customer orders, recording items related information based on scanning and identification of the items, and shipment processing (including shipping and logistics distribution of the items). It may also be understood that material handling environment described herein may refer to an environment having various equipment, including, for instance, any of machines like conveyor belt units, sorters, palletizers, and other scanning and identification based equipment's (including, but not limited to, barcode scanners, RFID readers, and bi-optic scanners) for tracking and tracing items as the items are processed while preparing customer orders for shipping.

A material handling environment may typically include various conveying arrangements, inter alia, a plurality of conveyors as exemplary supply arrangements for conveying items (e.g. shipment containers, totes, parcels, packages, cartons, and/or the like) from one location to another. In some examples, the material handling environment may also include sorters for sorting the items. Further, in some examples, the material handling environment may include various units like, but not limited to, scanners, imagers, actuators, controllers, robotic manipulators, and/or the like to perform one or more functions such as, but not limited to, detecting one or more addresses written on shipment containers, handling the containers, guiding the containers by means of various conveying units, weighing the containers, encoding data on labels affixed to the containers, etc. Furthermore, in some examples, item carriers such as, transport vehicles, trucks, pallet jacks, lorry, semi-trailer truck etc. may also be used to carry shipments within or outside of the material handling environment (e.g. warehouse). In some examples, a material handling installation site may include a transport carrier (e.g. a trailer) that may be parked at least in front of a conveyor to carry out the shipments from the trailer onto the conveyor or move the shipments into the trailer from the conveyor. Accordingly, items may be conveyed via the conveyors to the item carriers or vice versa. Having said that, in some examples, a floor of installations site, e.g. warehouse, may have a definite height (for example 1.2 m) which may correspond to a conventional height of storage space floor of the transport carriers. In some examples, conveyors in the installation site may then terminate on or in front of a correspondingly high loading ramp so that there is produced from the loading ramp a substantially planar transition to a storage space floor of a trailer located in front of the loading ramp. However, in some cases, a height of installation site can be greater or lower than the height of floor of the trailer, which often requires raising up or down of vehicle unloaders and moving or re-positioning the vehicle unloaders.

Manual loading/unloading of items can be costly, less productive, and inefficient. Further, item loading/unloading devices (for example, robotic manipulator, a boom conveyor also known as telescopic conveyor etc.) can be used typically in scenarios where raising up or lowering down a manipulator for handling items is desired. Said that, using the item loading/unloading devices within or outside of the material handling environment has associated challenges due to its complex design and large footprint.

Various example embodiments described herein relate to, an item conveying apparatus for conveying, loading, and/or unloading items in a material handling environment. The items referred herein may correspond to for example, but not limited to, pallets, goods, cartons, articles, containers, shipments, parcels, totes, packages, boxes, and/or the like. For purpose of brevity, these items handled by the item conveying apparatus (i.e. pallets, goods, cartons, articles, containers, shipments, parcels, totes, packages, boxes, and/or the like) are referred hereinafter collectively as ‘items’ throughout the description. The item conveying apparatus described herein can include a lift device and a conveyor. In an example, the lift device and the conveyor can be suspended from a ceiling of a material handling site. In this regard, the conveyor can be at least partially engaged with the lift device. The ceiling may correspond to a ceiling, roof, vault, and/or the like, of a material handling installation site. Said differently, various example embodiments described herein relate to the item conveying apparatus that can include the conveyor which can be ceiling mounted through the lift device. In an example, the conveyor may be operated for use with various transport carriers, such as, but not limited to, trucks, lorry, pallet jacks, or unit load devices (ULDs) typically used for transporting items. In this aspect, the lift device through which the conveyor can be suspended can be configured to manipulate a positioning of the conveyor.

In accordance with said example embodiments, the conveyor can include a conveyor frame and a plurality of conveyor segments. In an example, the plurality of conveyor segments can define a conveying surface for movement/conveyance of items. Further, each conveyor segment of the plurality of conveyor segments can be movable relative to the conveyor frame In other words, one or more conveyor segments of the plurality of conveyor segments can be pivotably engaged with others, so as to support a relative movement between two conveyor segments.

In an example embodiment, the material handling environment may include a control unit for example, a controller (e.g., but not limited to, controller of a warehouse management system) that may control operations of one or more components in the material handling environment. In an example embodiment, the control unit of the material handling environment may generate a command for operation of the conveyor. In this regard, upon receiving the command from the control unit, at least one conveyor segment of the conveyor can be adapted to move relative to the conveyor frame. For instance, in an example, at least one conveyor segment can be adapted to extend outwards to move the conveyor into an operational position. Furthermore, at least one conveyor segment of the conveyor can be adapted to retract or pulled backwards to move the conveyor into a parking position or a retracted position. Details of the operational position, parking position, and retracted position of the conveyor are described later at various instances throughout the description.

According to an example embodiment, the item conveying apparatus may include the lift device used for suspending the conveyor from the ceiling. In an example, the lift device can be an inverted scissor lift. The lift device can be configured to manipulate a position of the conveyor, for example, change a height of conveyor relative to a surface. In an example, the lift device can include at least two actuator elements e.g. actuator arms that can be engaged with an actuation platform coupled to a portion of the conveyor. Further, the actuator elements of the lift device can be adapted to raise or lower the actuation platform thereby raising or lowering a height of the conveyor relative to a surface.

In another example embodiment, the conveyor of the item conveying apparatus can be coupled to an item handling unit that can be configured to support automated loading and/or unloading of items through the conveyor. The item handling unit can be suspended from the ceiling through the lift device and can be coupled to the conveyor. According to an example embodiment, the item handling unit can include an item transfer section and a sectional floor unit. The item transfer section can correspond to an enclosure or a box module (like, but not limited to, a container carriage, a bogey, or a cargo carriage) that can receive a heap or stack of items that may be unloaded from a transport carrier (e.g. a vehicle). In accordance with an example embodiment, at least a portion of the item transfer section can be engaged to the lift device. Further, the sectional floor unit can be coupled to the item transfer section and can include one or more transfer flaps and a sectional floor garage defined beneath the conveyor.

In some examples, the lift device can allow powered movement of the items on a conveying surface of the conveyor, in an elevated position (i.e. ceiling mounted installation) without causing obstruction to ongoing movement of operators and/or machines within a material handling site. Further, the item conveying apparatus including the lift device and ceiling suspended conveyor can offer a light-weighted design, reduced footprint, and easy to install capability within the material handling environment at a much lesser cost, compared to conventional floor mounted conveyors. In this regard, ceiling mounted installation of the conveyor at the ceiling of the material handling environment, results in reducing a footprint or operational space of the material handling environment occupied by the conveyor. Furthermore, as stated earlier, such an installation and operation of the conveyor using the lift device can avoid causing obstruction of workers or other machines within the material handling environment.

Having described an example embodiments at a high level, the design of the various devices performing various example operations is provided below.

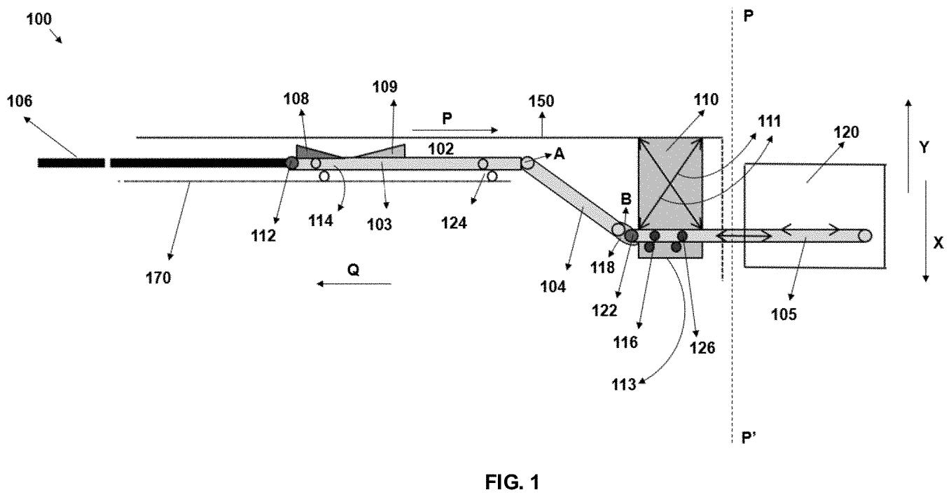

FIG. 1 schematically illustrates a first side-view 100 representing an item conveying apparatus 101 in a first state, in accordance with various example embodiments described herein. The first state herein represents an operational position of the item conveying apparatus 101. The item conveying apparatus 101 can include a conveyor 102 and other components supporting the conveyor 102. In an example, along with the conveyor 102, the item conveying apparatus 101 may also include one or more components that may support an installation or mounting of the conveyor 102, for example, with a ceiling of a material handling environment. For instance, in some examples, the item conveying apparatus 101 may include along with the conveyor 102, a lift device and/or a fixture that can support the conveyor 102.

In accordance with various examples described herein, the conveyor 102 can include a conveyor frame (not shown). Further, the conveyor 102 can comprise a conveying surface that can be defined based on various segments or movable portions. Illustratively, the conveyor 102 can comprise a plurality of conveyor segments (e.g. a first conveyor segment 103, a second conveyor segment 104, and a third conveyor segment 105). The plurality of conveyor segments 103, 104, and 105 can correspond to various segments or portions of the conveyor 102 that may collectively define the conveying surface of the conveyor 102 i.e. segments on which the items can be conveyed. The conveyor frame of the conveyor 102 can support the plurality of conveyor segments 103, 104, and 105 of the conveyor 102. In other words, according to an example, at least some portion of the plurality of conveyor segments 103, 104, and 105 can be positioned within a portion defined by the conveyor frame. To this end, in an example, the plurality of conveyor segments 103, 104, and 105 can be mounted on a portion of the conveyor frame of the conveyor 102. Although three conveyor segments 103, 104, and 105 are illustrated in FIG. 1, however, the conveyor 102 can comprise any number of conveyor segments, in accordance with various example embodiments described herein.

In one example embodiment, the plurality of conveyor segments 103, 104, and 105 can move relative to the conveyor frame in a telescopic fashion. In this regard, in such an implementation, at least a portion of the third conveyor segment 105 can be telescopically positioned within a portion of the second conveyor segment 104 which can further be telescopically positioned within a portion of the first conveyor segment 103. Alternatively, in another example embodiment, the plurality of conveyor segments 103, 104, and 105 may not be arranged in a telescopic fashion, however can be pivotably engaged relative to each other. In other words, each conveyor segment of the plurality of conveyor segments 103, 104, and/or 105 can be pivotably moved relative to remaining of the plurality of conveyor segments 103, 104, and/or 105. For instance, as illustrated in FIG. 1, the first conveyor segment 103 can be pivotably engaged to the second conveyor segment 104 about a point A and the second conveyor segment 104 can be pivotably engaged to the third conveyor segment 105 about a point B. Accordingly, the second conveyor segment 104 can be pivotably moved and positioned at an angle relative to any of the first conveyor segment 103 and/or the second conveyor segment 105.

According to an example embodiment, the conveyor frame of the conveyor 102 can be defined by two side rails. The two side rails may correspond to portions of conveyor frame which may run parallel to each other. In an example, the side rails of the conveyor frame can include one or more drive wheel assemblies engaged within a section of the conveyor frame. As stated earlier, the plurality of conveyor segments 103, 104, and 105 can define the conveying surface for an item and can be movable relative to the conveyor frame. Having said that, according to an example embodiment, the conveyor 102 can correspond to a telescopic conveyor (also referred as a boom conveyor) having multiple conveyor segments, i.e. the plurality of conveyor segments 103, 104, and 105 that can be telescopically extended out or pulled back relative to the conveyor frame.

In accordance with various example embodiments described herein, the item conveying apparatus 101 can include a lift device 110. Illustratively, the lift device 110 can be suspended from a ceiling 150, for example, a ceiling of a material handling site. In an example, the lift device 110 can be an inverted scissor lift. Unlike conventional floor mounted conveyors, in accordance with various example embodiments described herein, the conveyor 102 can be ceiling mounted, i.e. at least a portion of the conveyor 102 can be mounted on the ceiling 150. For instance, as illustrated, the conveyor 102 can be mounted on the ceiling 150 through the lift device 110 suspended from the ceiling 150. In this regard, in an example embodiment, at least a portion of the conveyor frame of the conveyor can be at least partially engaged a portion of the lift device 110.

In accordance with various example embodiments described herein, the lift device 110 can be configured to manipulate a positioning of the conveyor 102. For instance, the lift device 110 can manipulate a position of the conveyor 102 to lower a height at which the conveyor 102 is suspended from the ceiling 150 (or positioned relative to a ground surface). Further, the lift device 110 can also manipulate a position of the conveyor 102 to raise a height at which the conveyor 102 is suspended from the ceiling 150 (or positioned relative to the ground surface). Illustratively, the lift device 110 can comprise at least two actuator elements 111 coupled to an actuation platform 113. The actuation platform 113 can be coupled to at least a portion of the conveyor 102. For example, as illustrated, the actuation platform 113 can be mechanically coupled to one or more of the plurality of conveyor segments 103, 104, and 105 of the conveyor 102. In an example embodiment, the at least two actuator elements 111 of the lift device 110 can be adapted to lower the actuation platform 113 in a direction X, e.g. towards a ground surface. Further, the at least two actuator elements 111 of the lift device 110 can be adapted to raise the actuation platform 113 in a direction Y, e.g. opposite to the direction X and towards the ceiling 150. In this regard, lowering the actuation platform 113 of the lift device 110 can lower a height of the conveyor 102 relative to a ground plane. Further, raising the actuation platform 113 can raise a height of the conveyor 102 relative to the ground plane. In some examples, height of the conveyor 102 can be raised or lowered so as to match a height of a platform e.g. of a transport carrier for loading or unloading items.

FIG. 1 illustrates, a first state, i.e. an operational position of the conveyor 102. In the operational position, the conveyor 102 can be extended towards a section through which one or more items are to be loaded or unloaded. In an example, conveyor 102 can be extended towards a section of a transport carrier. Extending the conveyor 102 as referred herein may include extending an end or a section, for example, one or more conveyor segments of the plurality of conveyor segments 103, 104, and 105 of the conveyor 102. In this regard, in an example, one or more of the plurality of conveyor segments 103, 104, and 105 can be telescopically extended outwards from the conveyor frame. For instance, as illustrated, the plurality of conveyor segments 103, 104, and 105 of the conveyor 102 can be extended outwards such that a portion of the conveyor segment 105 crosses beyond a plane PP′. Illustratively, for manipulating the position of the conveyor 102 to the operational position, the conveyor segments 104 and 105 can be extended out so as to interface with a carrier accumulation zone 120 (e.g. a section of a transport carrier). In an example, the carrier accumulation zone 120 may correspond to a platform of the transport carrier (e.g. a vehicle) carrying multiple items. In this regard, one or more conveyor segments of the conveyor 102 can be telescopically or non-telescopically extended outwards so as to interface a portion of the carrier accumulation zone 120 with a portion of the conveying surface of the conveyor 102. Upon such an interfacing, items can be moved from the conveyor 102 onto the carrier accumulation zone 120 or vice versa.

According to an example embodiment, the conveyor 102 can be a roller conveyor. The roller conveyor can comprise the conveying surface for the item defined by plurality of rollers. Further, the roller conveyor can be defined between two side rails of the conveyor frame where the rollers can be engaged between the two side rails and defines the conveying surface. In another example embodiment, the conveyor 102 can be a belt conveyor comprising a conveyor belt. The conveyor belt can provide a conveying surface for conveying the items. The belt conveyor can comprise two or more pulleys with an endless loop of the conveyor belt which may rotate about it.

According to various example embodiments described herein, the item conveying apparatus 101 can comprise a plurality of drive wheels and/or support wheel assemblies. These assemblies can be positioned within side rails defined by the conveyor frame of the conveyor. The drive wheel and/or support wheel assemblies can be adapted to move one or more components of the conveyor 102. As illustrated in FIGS. 1-3, the item conveying apparatus 101 can include, conveyor drive wheel assemblies 112 and 122. The conveyor drive assemblies 112 and 122 can comprise one or more motor driven rollers and a corresponding conveyor belt that can be moved by the motor driven rollers. In this regard, conveyor drive assemblies 112 and 122 can be actuated by a control unit of the conveyor 102 to initiate movement of a conveyor belt to convey items.

Further, in an example embodiment, the conveyor 102 can include support wheel drive assemblies 114 and 124. The support wheel drive assemblies 114 and 124 can comprise one or more support wheels. The support wheels may be adapted to support at least one conveyor segment of the conveyor 102. As illustrated, the support wheels of the support wheel drive assemblies 114 and 124 can support the second conveyor segment 104 relative to a surface 170 of the item conveying apparatus 101. In other words, the support wheels of the support wheel assemblies 114 and 124 can provide support to the conveyor segments 103, 104, and/or 105 as these segments are moved forward (i.e. in direction P) or backward (i.e. in direction Q) for extending or retracting the conveyor 102, in a respective direction. The support wheels can be of any shape, form, structure or size depending on requirements of installation of the conveyor 102.

Furthermore, according to an example embodiment, as illustrated in FIGS. 1-3, the conveyor 102 can include frictional driving wheel assemblies 116 and 126. The frictional drive wheel assemblies 116 and 126 can comprise frictional wheels or sprockets. In an example, the frictional wheels can correspond to wheels covered with a material of high frictional coefficient. For example, the frictional wheels may include wheels covered with rubber caps. In this case, frictional drive wheel assemblies 116 and 126 may also include two pressure wheels opposing to the frictional wheels. In an example, the frictional drive wheel assemblies 116 and 126 may move within sideguards engaged on side rails of a conveyor frame of the conveyor 102. In an example, use of the friction wheels of the frictional drive wheel assemblies 116 and 126 can facilitate controlled movement of one or more of the plurality of conveyor segments 103, 104, and 105 of the conveyor 102. In another example embodiment, the frictional driving wheel assemblies 116 and 126 may include a tooth belt and pulley-based arrangement for driving one or more of the telescopic segments 103, 104, and 105 of the conveyor 102.

In accordance with some example embodiments described herein, wheels of the wheel assemblies described herein may be mounted within side rails at both sides of the conveyor frame. In this aspect, the wheels may be fitted, in such a manner, that the plurality of conveyor segments 103, 104, and 105 of the item conveying apparatus 101 can be moved, i.e. retracted or extended relative to the conveyor frame based on rolling of the wheels within the side rails in a longitudinal direction of the conveyor frame. In some example embodiments, the item conveying apparatus 101 may further comprise a motor which can drive at least one of the plurality of wheels by means of a gear both in the forward and in the backward direction to facilitate extension or retraction of one or more of the conveyor segments 103, 104, 105 of the conveyor 102.

In some example embodiments, the conveyor 102 of the item conveying apparatus 101 may be positioned aside with a feed conveyor (e.g. an infeed conveyor and/or an outfeed conveyor) referred hereinafter, as a source conveyor 106. The source conveyor 106 may operate as an infeed conveyor (i.e. a conveyor that facilitates infeed of items) or an outfeed conveyor (i.e. a conveyor that facilitates outfeed of items) depending on items being conveyed into a section or area of the material handling environment or out from the material handling environment. For example, the source conveyor 102 can operate as an infeed conveyor in situations where one or more items are to be unloaded from a transport carrier and an inflow of the one or more items can be moved into a storage area or section of the material handling environment. Similarly, the source conveyor 102 can operate as an outfeed conveyor in situations where one or more items are to be moved out from a storage location or section of the material handling environment, for instance, for loading the items onto the transport carrier for transit.

Illustratively, the conveyor 102 can be installed aside of the source conveyor 106. As illustrated, the conveyor 102 may include a first side deflector 108 and the source conveyor 106 may include a second side deflector 109. The first side deflector 108 and the second side deflector 109 can be of any shape, size, or structure. For example, the first side deflector 108 and the second side deflector 109 can correspond to an extension or extended portion of conveyor frame itself or a triangular bar, and/or the like, that may enable deflection of an incoming or outgoing item. In an example, the first side deflector 108 and the second side deflector 109 may be actuated by a control unit (not shown) of the conveyor 102, to facilitate a deflection of the items. In this regard, the first side deflector 108 and/or the second side deflector 109 may be adapted to deflect an incoming item i.e. item incoming from the source conveyor 106 onto the conveyor 106 or alternatively, items incoming on the source conveyor 106 from the conveyor 102.

In an example embodiment, for infeed, i.e. unloading items from the transport carrier, the item conveying apparatus 101 including the conveyor 102 can be installed above the source conveyor 106. In an example, at least a portion of the conveyor 102 may extend so as to define a segment forming an inclined path or a slide that may facilitate dropping of the items moving on the conveyor 102 in a waterfall fashion on to the source conveyor 106. In this aspect, as the items waterfalls from the conveyor 102 onto the source conveyor 106, the items can be moved on the source conveyor 106 towards a storage area or a section (e.g. a container accumulation zone) inside the material handling environment.

In another example embodiment, for out-feed, i.e. for loading items into the transport carrier, the item conveying apparatus 101 including the conveyor 102 can be installed below the source conveyor 106. In an example, at least a portion of the source conveyor 106 may extend so as to define a segment forming an inclined path or a slide which facilitates dropping of the items moving on the source conveyor 106 on to the conveyor 102 in a waterfall fashion. In this aspect, as the items waterfalls from the source conveyor 106 on to the conveyor 102, the items are moved on extended conveyor segments 103, 104, and 105 and further inside the transport carrier. In an example, an end of the conveyor 102 may be accessible to an operator to take down incoming items from the conveyor 102 and to move it into the carrier accumulation zone 120 of the transport carrier.

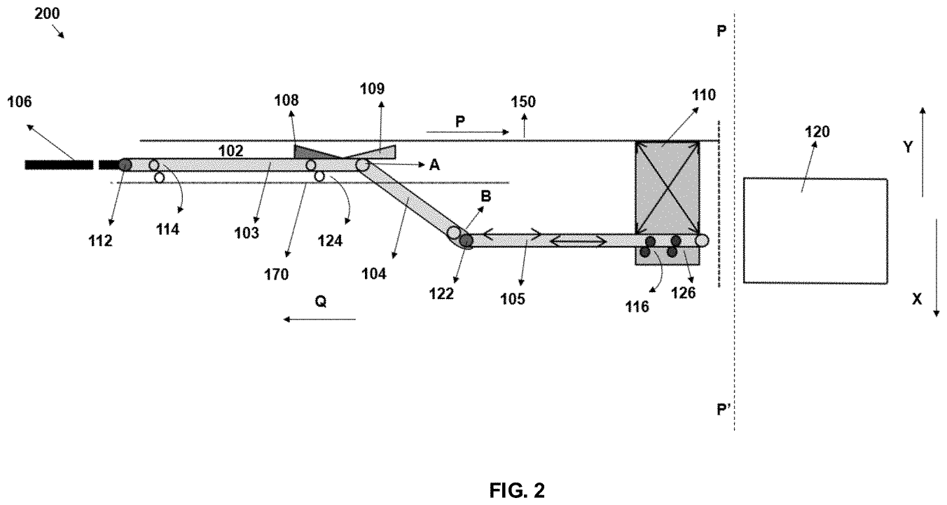

FIG. 2 schematically illustrates a second side-view 200 representing the item conveying apparatus 101 in a second state, in accordance with various example embodiments described herein. The second state of the item conveying apparatus 101, as illustrated in FIG. 2, represents a retracted position of the conveyor 102. In the retracted position, the plurality of conveyor segments 103, 104, and 105 of the conveyor 102 can be at least partially retracted or pulled back. In an example, in the retracted position, at least one conveyor segment of the plurality of conveyor segments 103, 104, and 105 can be at least partially retracted within a portion of the conveyor frame. For instance, compared to position of the third conveyor segment 105 illustrated in FIG. 1, in the retracted position, the third conveyor segment 105 is positioned before the plane PP′. In other words, the retracted position of the conveyor 102 represents a state in which the one or more conveyor segments of the plurality of conveyor segments 103, 104, and/or 105 of the conveyor 102 may be pulled back in the direction Q.

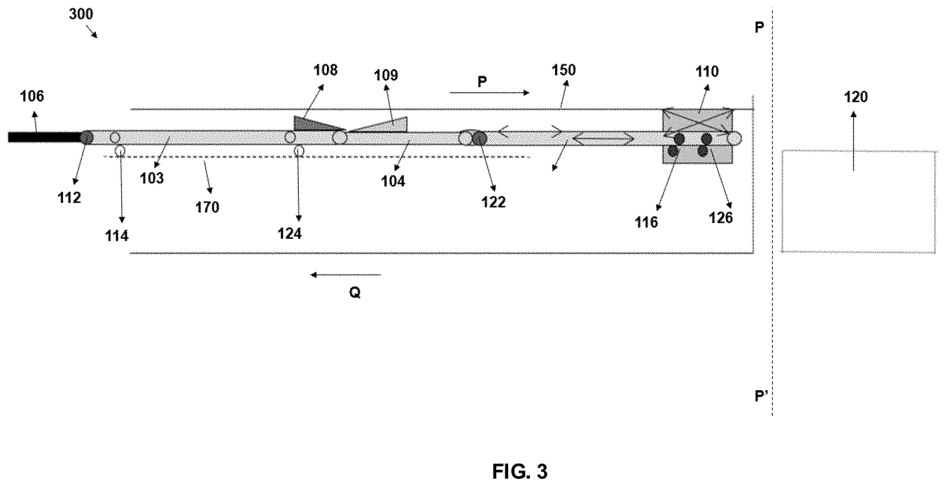

Accordingly, as described in various example embodiments herein, by moving one or more of the plurality of conveyor segments 103, 104, and/or 105, the conveyor 102 can be extended to an operational position, i.e. the first state (as illustrated in FIG. 1) or can be retracted back into the retracted position, i.e. the second state (as illustrated in FIG. 2). Further, in some examples, the conveyor 102 can further be retracted more into a parking position, details of which are described in reference to FIG. 3.

FIG. 3 schematically illustrates a third side-view 300 representing the item conveying apparatus 101 in a third state, in accordance with various example embodiments described herein. The third state of the item conveying apparatus 101 represents a parking position of the conveyor 102. In an example, the conveyor 102 can be moved to the parking position in response to completion of a movement of items on the conveyor 102 i.e. when no conveyance operation is being performed by the conveyor 102. In other words, when the conveyor 102 is in the parking position, no movement of items on the conveyor 102 can be performed. While in the operational and retracted positions of the conveyor 102 (as illustrated in FIGS. 1 and 2 respectively), the conveyor 102 is lowered down (i.e. in the direction X), in the parking position (as illustrated in FIG. 3) the conveyor 102 can be raised up (i.e. in the direction Y). In this regard, as illustrated in FIG. 3, the actuation platform 112 of the lift device 110 can be raised up in the direction Y, thereby, raising the conveyor 102 to a parking height. In an example, the parking position may correspond to a standby position and the parking height corresponds to a height at which the conveyor 102 may be positioned when no further operation of the conveyor 102 is desired. Said differently, in the operational or retracted position of the conveyor 102, the conveyor 102 can be lowered down by the lift device 110 so as to interface with a platform which may receive or transfer items through the conveyor 102. However, in the parking position, the conveyor 102 can be raised back up closer towards the ceiling.

Further, in the parking position, the plurality of conveyor segments 103, 104, and/or 105 of the conveyor 102 can be at least partially retracted or pulled back in the direction Q. In this regard, in an example where the conveyor 102 corresponds to a telescopic conveyor, in the parking position, the third conveyor segment 105 and the second conveyor segment 104 can be telescopically pulled within a portion of the conveyor frame of the conveyor 102. Furthermore, in the parking position, each conveyor segment of the plurality of conveyor segments of the conveyor 102 can be positioned in a substantially colinear manner relative to another. In other words, while in the first state or the second state of the conveyor 102, the conveyor segment 104 is positioned at an angle relative to the conveyor segments 103 and 105 (e.g. forming a Z shape bend), in the parking position, the plurality of conveyor segments 103, 104, and 105 can be positioned relatively in a straight-line formation.

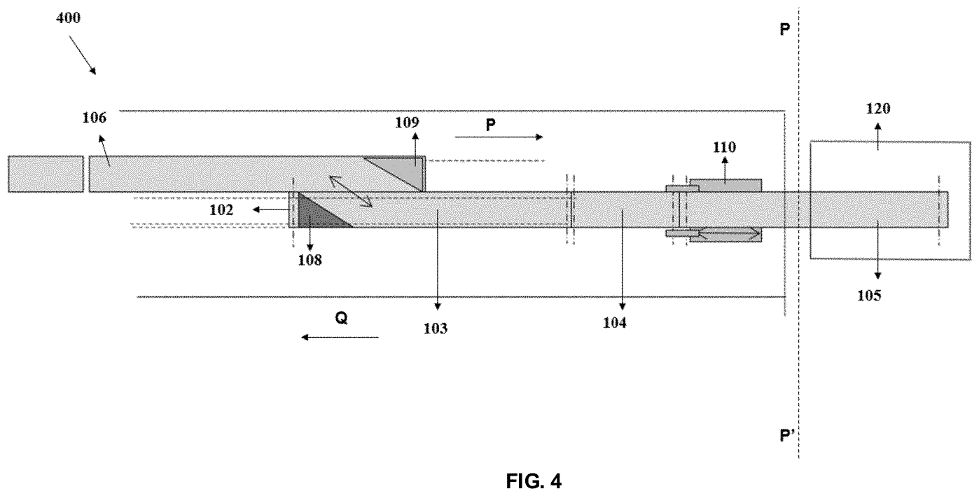

FIG. 4 schematically illustrates a first top view 400 of the item conveying apparatus 101, in accordance with some example embodiments described herein. The first top view 400 illustrates a top view of the item conveying apparatus 101 including the conveyor 102 in the first state, i.e. the operational state, as described earlier in reference to FIG. 1. Illustratively, the conveyor 102 is positioned aside a feed conveyor, i.e. the source conveyor 106. Further, the first side deflector 108 and the second side deflector 109 are positioned on the conveyor 102 and the source conveyor 106 to deflect incoming items from one conveyor to the other, in a manner, as described earlier.

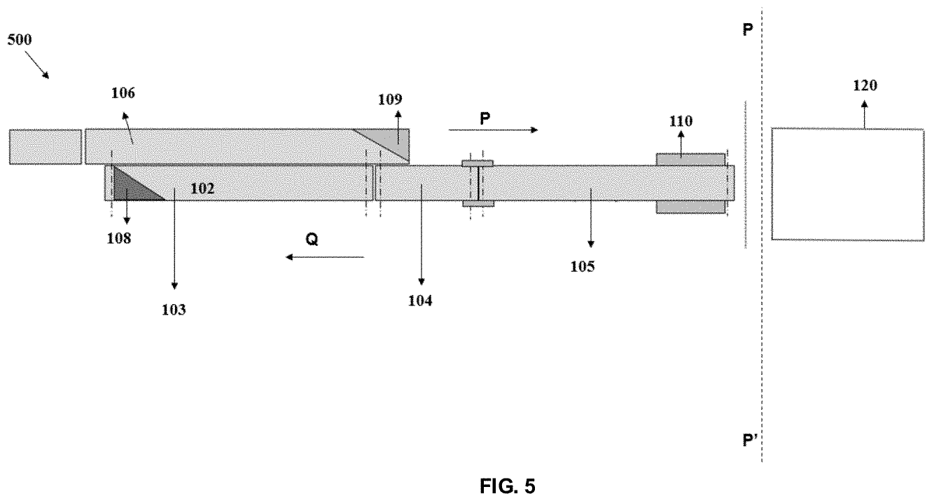

FIG. 5 schematically illustrates a second top view 500 of the item conveying apparatus 101, in accordance with some example embodiments described herein. The second top view 500 illustrates a top view of the item conveying apparatus 101 including the conveyor 102 in the second state, i.e. the retracted position, as described earlier in reference to FIG. 2. As illustrated, in the retracted position, one or more conveyor segments of the conveyor 102 can be pulled back at least partially in the direction Q. In this regard, as described earlier, in the retracted position, the third conveyor segment 105 can be pulled back and positioned before the plane PP′.

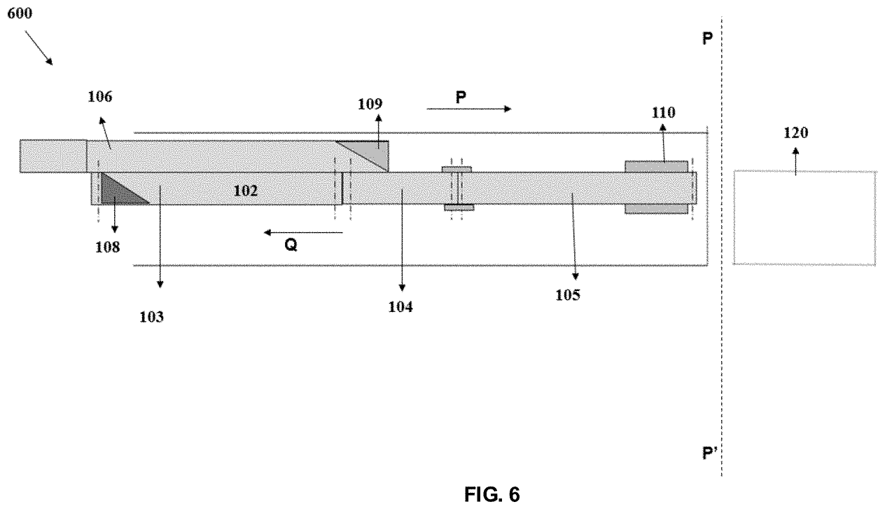

FIG. 6 schematically illustrates a third top view 600 of the item conveying apparatus 101, in accordance with some example embodiments described herein. The third top view 600 illustrates, the item conveying apparatus 101 in the parking position, as described earlier in reference to FIG. 3.

As stated earlier, in accordance with various example embodiments described herein, the item conveying apparatus 101 can include the control unit. The control unit may, for example, comprise at least one processor and at least one memory. In an example, the processor can be configured to carry out programs which are stored in the memory and thereby to cause the item conveying apparatus 101 to carry out desired actions. For example, in some example embodiments, a control panel of the control unit may be positioned at a free end of the item conveying apparatus 101 and may be accessible to an operator. In this regard, the control panel may include one or more controls that can allow an operator to control various functions of the item conveying apparatus 101. For instance, in an example, such controls may be used by the operator for controlling an extension of one or more of the plurality of conveyor segments 103, 104, and 105 of the conveyor 102 of the item conveying apparatus 101. In another example, such controls may be used for providing a direction of conveying operation (loading or unloading) or stopping/starting execution of an operation by the conveyor 102. In some example embodiments, these controls may include physical buttons which can be actuated by upon pressing by the operator. In some example embodiments, these controls may be defined within a graphical user interface as actuatable icons, displayed on a screen of the graphical user interface, or may include soft touch keys which can be used by the operator for actuation of different units of the item conveying apparatus 101 to carry out desired operations. In some example embodiments, the control panel of the item conveying apparatus 101 may also control an operation of height adjustment of the item conveying apparatus 101.

In some example embodiments, the control unit may be communicatively coupled to one or more components of the conveyor 102, for example, motors, sensors, etc. In some example embodiments, the control unit could also be connected to a radio receiver or a radio-based transmission/receiving device of another control unit within a material handling environment for a wireless communication with the control unit.

In some example embodiments, the item conveying apparatus 101 may also include a platform (not shown herein) that may extend from one end of the conveyor 102. For instance, in an example, the item conveying apparatus 101 may include the platform extending from an end of the third conveyor segment 105. In some examples, while operating the item conveying apparatus 101, the operator may stand on the platform to perform one or more operations e.g. loading or unloading of items on the conveyor 102. In this regard, in an example, the platform may be positioned at a correct height by raising up or lowering down one or more conveyor segments 103, 104, and 105 of the item conveying apparatus 101. The operator may then perform operations for example but not limited to, picking up the items from the conveyor 102 and placing it within a zone e.g. the carrier accumulation zone 120 of the transport carrier and vice versa.

In accordance with various example embodiments described herein, the item conveying apparatus 101 may have a light weight design. In this aspect, the roller conveyor 102 and associated equipment of the item conveying apparatus 101 may be made of pre-stressed aluminum-based sheets which are supported by side guides which encapsulates the item conveying apparatus 101 to prevent any bending or undesired inclination of the item conveying apparatus 101.

In some example embodiments described herein, the item conveying apparatus 101 may also comprise various operating elements and sensors. In some examples, these operating elements may allow the operators inter alia to bring about a movement of the item conveying apparatus 101 into any of the parking position, the retracted position 100, or into the operating position, as described earlier in reference to FIGS. 1-3. In some example embodiments, the control panel of the control unit, may also allow an operator to bring about a start, a stoppage, an emergency stop to an operation of the item conveying apparatus 101 or an emergency stop of movement of one or more of the conveyor segments 103, 104, or 105 of the conveyor 102. In some example embodiments, a sensor may be provided to register that the conveyor 102 is moved to one of, the retracted position, or the parking position, and/or the operating position.

According to said example embodiments, by way of ceiling mounted installation of the item conveying apparatus 101, the conveyor 102 can be positioned off from a ground surface i.e. with some portion of the ceiling, thereby, reducing a footprint and saving a lot of space occupancy of the material handling environment. Further, it also supports controlling and adjusting a height of the conveyor 102 relative to a platform of the transport carrier 120.

In an example embodiment, the lift device 110 of the item conveying apparatus 101 may correspond to an inverted scissor lift that may include at least two actuator elements positioned in a crisscrossed fashion and an actuation platform that may be mechanically engaged to at least a portion of the conveyor 102. In this regard, the actuator elements may be adapted to: move down the actuation platform so as to lower a height of the conveyor 102 relative to a ground plane. Further, the actuator elements may also be adapted to move up the actuation platform raise the conveyor 102 to a defined height relative to the ground plane.

In accordance with some example embodiments, the control unit of the item conveying apparatus 101 may also control operations of the lift device 110 for controlling upward or downward movement of the conveyor 102.

In an example embodiment, the item conveying apparatus 101 may also include an interlocking unit 118, for example, a solenoid based powered metal segment, that can support interlocking of the conveyor wheel drive assembly with the support wheel drive assembly of the conveyor 102, thereby blocking a relative movement between two conveyor segments. For example, the interlocking unit 118 may support interlocking of the second conveyor segment 104 with the third conveyor segment 105. In accordance with an example embodiment, as the conveyor 102 is moved into the operational position 100, the second conveyor segment 104 and the third conveyor segment 105 can extend so as to facilitate transport of an item from the carrier accumulation zone 120 on the conveyor 102 and vice versa. In this regard, as the second conveyor segment 104 extends and gets inclined with respect to the conveyor segments 103 and 105, in some examples, the interlocking unit 118 can interlock and block a relative movement between the conveyor segments 104 and 105. In other words, interlocking by the interlocking unit 118, can create a stiff formation between the two conveyor segments i.e. the second conveyor segment 104 and the third conveyor segment 105 (i.e. as of being a single unit), thereby, preventing any relative movement. Further, based on the interlocking, if a further movement of the conveyor 102 i.e. in the direction P or the direction Q is attempted by the lift device 110, each conveyor segment interlocked by the interlocking unit 118 can move together as a single unit. Furthermore, in an example embodiment, the interlocking unit 118 may additionally compensate for any torque which may be generated by, for example, a movement of the third conveyor segment 105 in forward direction (i.e. the direction P) or backward direction (i.e. the direction Q) and/or due to load of the item moving on the conveyor 102 of the item conveying apparatus 101.

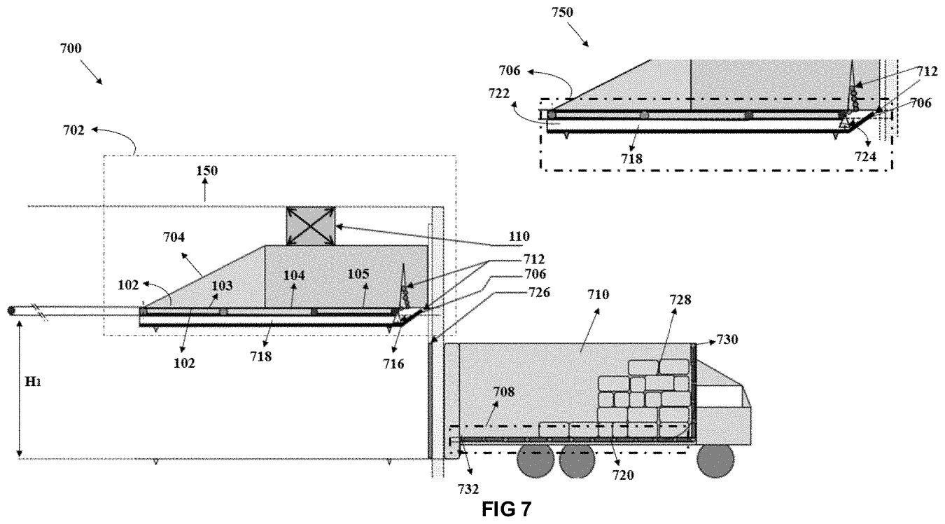

In an example, the item conveying apparatus 101 may be installed in a configuration so as to facilitate automated loading and/or unloading of items (for example, without any manual intervention) from the conveyor 102 to the item accumulation zone 120 of the transport carrier and vice versa, details of which are described hereinafter in reference to FIGS. 7-10.

FIG. 7 schematically illustrates a first view of such an example of such implementation of the item conveying apparatus 101. Illustratively, in an example embodiment, the item conveying apparatus 101 may include an item handling unit 702. In one example embodiment, the item handling unit 702 may include one or more components that may be mechanically coupled to the conveyor 102. In another example embodiment, the conveyor 102 may be a part of item handling unit 702 itself. In this regard, the item handling unit 702 can include including at least the conveyor 102 and the lift device 110 that may be installed in such a configuration that can facilitate automated loading and/or unloading of items through the conveyor 102, i.e. a ceiling mounted conveyor.

According to an example embodiment, the item handling unit 702 may include an item transfer section 704 and a sectional floor unit 706. The item transfer section 704 may correspond to a section or an enclosure that may be adapted to transfer or receive one or more items. In an example, the item transfer section 704 may receive from the transport carrier, an item or a pack of items (i.e. multiple items stacked or piled up in any manner). In an example embodiment, the item transfer section 704 may be suspended from the ceiling 150 of the material handling environment. In this regard, the item transfer section 704 may be suspended from the ceiling through the lift device 110. In an example, the lift device 110 can correspond to the inverted scissor lift, as described in earlier in reference to FIGS. 1-6. In an example embodiment, at least a portion, for example, the actuation platform 113 of the lift device 110 can be mechanically engaged to a portion of the item transfer section 704. In this regard, actuating the actuator elements 111 of the lift device 110 to raise up or lower down the lift device 110 may cause raising up or lowering down of the item transfer section 704. Further, the conveyor 102 may be coupled to at least some portion of the item transfer unit 704, for instance, based on any mechanical engagement.

According to an example embodiment, the item handling unit 702 may also comprise a sectional floor unit 706. The sectional floor unit 706 may correspond to a floor section that may be coupled to the item transfer section 704. In an example, the sectional floor unit 706 may comprise components that may mechanically interface with a platform of a transport carrier or an item carrying unit. For instance, in an example, the sectional floor unit 706 may be configured to interface with an item carriage section 708 of a vehicle 710 (e.g. a transport carrier). According to an example embodiment, the sectional floor unit 706 of the item handling unit 702 can comprise a transfer flap 712 and a sectional floor garage 718, details of which are described in following paragraphs.

As illustrated, the transfer flap 712 can be coupled to an end 716 (e.g. a distal end) of the conveyor 102. The transfer flap 712 can be adapted to pivotably move about a point from a raised-up position to a lowered down position. Here, the end 716 of the conveyor 102 can correspond to a portion that may be interfaced with a portion of the item carriage section 708 of the vehicle 710. Said that, in an example, the transfer flap 712 may be initially in a raised-up position and can be moved to the lowered down position (e.g. rotatably moved 90 degrees), in a situation, when it may be required to interface the end 716 of the conveyor 102 with the item carriage section 708 of the vehicle 710. In other words, the transfer flap 712 may be lowered down to cause interfacing of the sectional floor unit 706 with the item carriage section 708 of the vehicle 710.

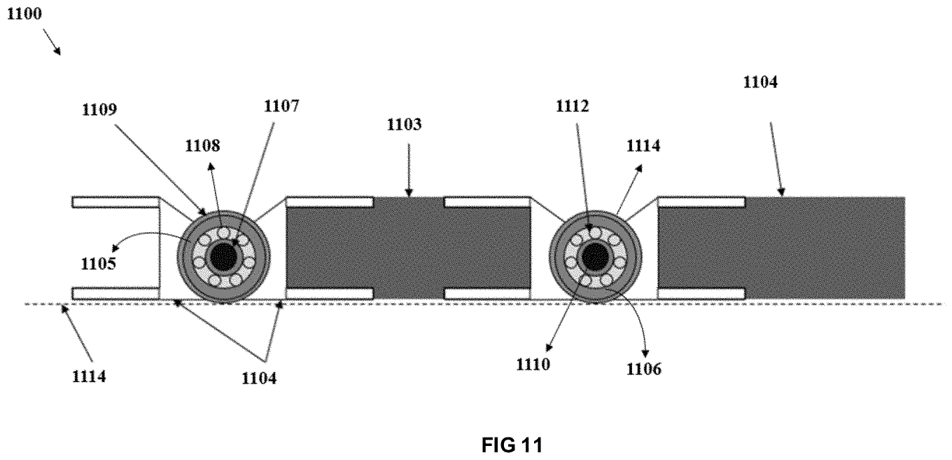

Illustratively, the sectional floor unit 706 may also include a sectional floor garage 718. The sectional floor garage 718 may correspond to a section that may be defined beneath the conveyor 102. In an example, the sectional floor garage 718 may correspond to an enclosure (like a channel) that can be configured to receive a sectional floor surface 720 of the vehicle 710. The sectional floor surface 720 of the vehicle 710 may be like a floating floor surface, i.e. a surface that can be adapted to slidably move within a portion defined by the item carriage section 708 using one or more drive cables. In this regard, the sectional floor surface 720 may be defined based on an arrangement of multiple sectional floor plates and drive wheel assemblies, further details of which are described in reference to FIG. 11.

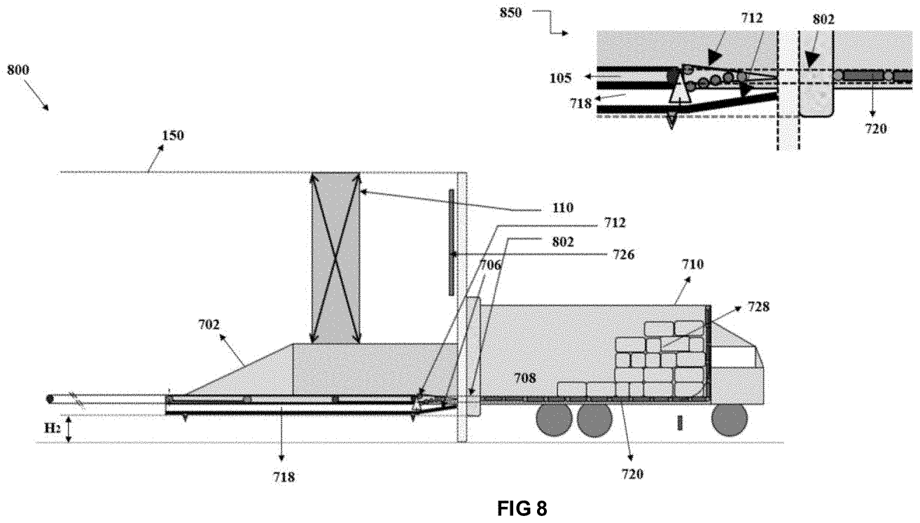

FIG. 7 also illustrates a close-up (i.e. zoomed-in) view of the sectional floor unit 706. Illustratively, the sectional floor garage 718 is defined between a first end 722 and a second end 724 beneath the conveyor 102. Details of the sectional floor surface 720 and its receiving in the sectional floor garage 718 are described later in reference to FIGS. 8-10.

FIG. 7 schematically illustrates a first operating state 700 of the item handling unit 702. In the first operating state 700, the item transfer section 704 along with the conveyor 102 is in a raised-up position. In the raised-up position the conveyor 102 may be at a positioned at a first height H₁ relative to a ground surface. Further, the vehicle 710 including a stack of items 728 is positioned close to a loading gate 726 of the material handling environment. The stack of items 728 can correspond to any of shipments, containers, articles, etc., as described earlier. Moving to FIG. 8, a second operating state 800 of the item handling unit 702 is illustrated. In the second operating state 800, the item transfer section 704 of the item handling unit 702 can be moved to a lowered down position. In the lowered-down position, the conveyor 102 may be positioned at a second height H₂ (i.e. a height<the first height H₁) relative to the ground surface. In this regard, the conveyor 102 along with the item handling unit 702 can be lowered down by actuation of the actuator elements 111 of the lift device 110, in a similar manner, as described earlier. Further, in the second operating state 800, as illustrated in FIG. 8, the loading gate 726 of the material handling environment can be raised up (i.e. opened up for loading and/or unloading the items). Furthermore, in the second operating state 800, the sectional floor unit 706 can be interfaced with the item carriage section 708 of the vehicle 710.

Interfacing the sectional floor unit 706 with the item carriage section 708 may involve for example, (a) positioning the item handling unit 702 at a desired height such that the conveying surface of the conveyor 102 and the sectional floor surface 720 of the item carriage section 708 may be at a similar height relative to the ground surface, (b) lowering down of the transfer flap 712 so as to bridge the conveying surface with the sectional floor surface 720 of the vehicle 710, and (c) connecting the conveying surface of the conveyor 102 and the sectional floor surface 720 of the item carriage section 708 with one or more drive cables 802. FIG. 8 also illustrates a close-up (i.e. zoomed-in) view 850 of the interfacing of the sectional floor unit 706 including the conveyor surface of the conveyor 102 with the sectional floor surface 720 of the item carriage section 708 of the vehicle 710.

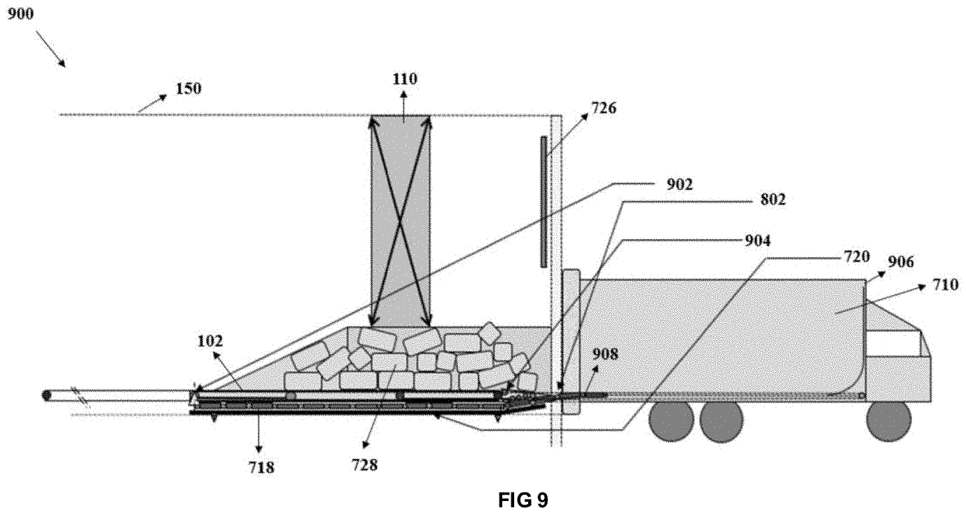

In an example embodiment, the sectional floor unit 706 of the item handling unit 702 can be coupled to the item carriage section 708 of the vehicle 710 based on an interfacing of the transfer flap 712 with the portion of the item carriage section 708 and a connection of a first drive cable of the sectional floor unit 706 to a second drive cable of the item carriage section 708. In this regard, in an example embodiment, at least one of the first drive cable and the second drive cable can be configured to slidably pull the sectional floor surface 720 of the vehicle 710 into the sectional floor garage 718, details of which are illustrated in FIG. 9.

FIG. 9 schematically illustrates a third operating state 900 of the item handling unit 702 of the item conveying apparatus 101, in accordance with some example embodiments described herein. In the third operating state 900, the stack of items 728 may be unloaded from the item carriage section 708 of the vehicle 710 onto the conveyor 102. Illustratively, the stack of items 728 unloaded from the vehicle 710 can be received in an enclosure defined by the item transfer section 704. In this regard, the stack of the items 728 can be received over the conveying surface of the conveyor 102. For unloading the stack of items 728, as illustrated, the sectional floor surface 720 of the item carriage section 708 may be pulled or moved into the sectional floor garage 718. To this end, in an example, the drive cables 802 may be configured to slidably pull the sectional floor surface 720 into the sectional floor garage 718 beneath the conveyor 102 of the item handling unit 702. In an example, the sectional floor unit 706 may include a mover element 902 that may be moved to multiple positions e.g. a stand-by position, an engaged position, or into an unloading position for interfacing and pulling the sectional floor surface 720 of the vehicle 710. In an example, a member 904 (e.g. a metal sheet or an interfacing plate) may be positioned at interfacing junction of the conveyor 102 and the sectional floor surface 720 such that, as the sectional floor surface 720 is slidably pulled into the sectional floor garage 718, the stack of items 728 are moved onto the conveying surface of the conveyor 102.

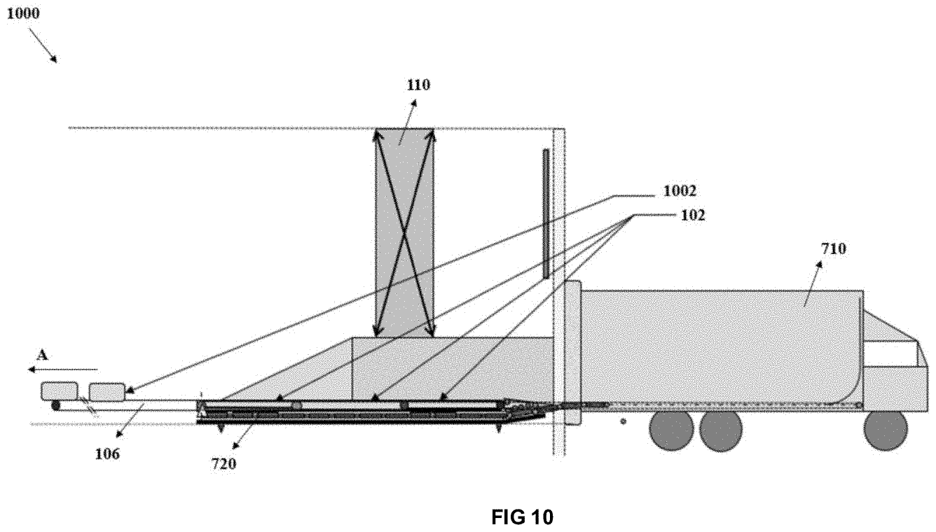

FIG. 10 schematically illustrates a fourth operating state 100 of the item handling unit 702 of the item conveying apparatus 101, in accordance with some example embodiments described herein. In the fourth operating state 1000, one or more items 1002 from the stack of items 728 may be conveyed onto the source conveyor 106 by the conveyor 102. For instance, as the stack of items 728 is unloaded on the conveyor 102 from the vehicle 710, one or more items from the stack of items 728 can be further conveyed onto the source conveyor 106 and further transported by the source conveyor 106 into a section (e.g. a singulation section) of the material handling environment. Thereafter, the items from the stack of items 728 may be singulated (i.e. separated) and further sorted and moved into respective storage locations. FIG. 10, illustrates the one or more items 1002 may be conveyed in a direction A by the source conveyor 106 into a source location (e.g. a storage location or a singulation section) of the material handling environment.

Further, in an example embodiment, upon unloading the stack of items 728 onto the conveyor 102, the sectional floor surface 720 can be pulled back into the portion of the item carriage section 708 of the vehicle 710. Furthermore, the loading gate 726 can be lowered down and the item handling unit 702 can be raised up into the first operating state 700, as described in FIG. 7.

FIGS. 7-10 illustrates an example implementation of the item conveying apparatus 101 having the item handling unit 702 where the conveyor 102 can be used for unloading the stack of items 728 from the vehicle 710. Alternatively, and/or additionally, in another example embodiment, an installation of the item conveying apparatus 101, as illustrated in FIGS. 7-10 can also be used for loading of one or more items (e.g. either individually or in stacked form) from the conveyor 102 onto the item carriage section 708 of the vehicle 710.

FIG. 11 schematically illustrates a side view 1100 of a portion the sectional floor surface 720 of the vehicle 210, in accordance with some example embodiments described herein. As described earlier, the sectional floor surface 720 of the vehicle 710 can be defined as a floating floor surface (i.e. a surface that can be adapted to slidably move within a portion defined by the item carriage section 708) using one or more drive cables. The portion referred herein may correspond to a channel like structure defined between a first end 906 and a second end 908 of the item carriage section 708 of the vehicle 710, as illustrated in FIG. 9. Illustratively, the sectional floor surface 720 can be defined based on a plurality of sectional floor plates (e.g. a first sectional floor plate 1103 and a second sectional floor plate 1104) that can be mechanically engaged (e.g. encased) between flanges 1104 and drive assemblies (e.g. a first drive assembly 1105 and a second drive assembly 1106). In an example, the flanges 1104 illustrated herein, can correspond to injection molded compact flanged connection (CFC). In an example, the sectional floor surface 720 may be positioned over a surface 1114 e.g. a surface of the item carriage section 708. The drive assemblies may include drive wheels or sprockets, shafts, ball bearings, and drive pulleys. For instance, as illustrated, the first drive assembly 1105 may include a first shaft 1107, first ball bearings 1108, and a first pulley 1109 and the second drive assembly 1106 may include a second shaft 1110, second ball bearings 1112, and a second pulley 1114. Such an arrangement facilitates slidable movement of the sectional floor surface 720 along a portion of the item carriage section 708 of the vehicle 710 and further into the sectional floor garage 718 of the item handling unit 702.

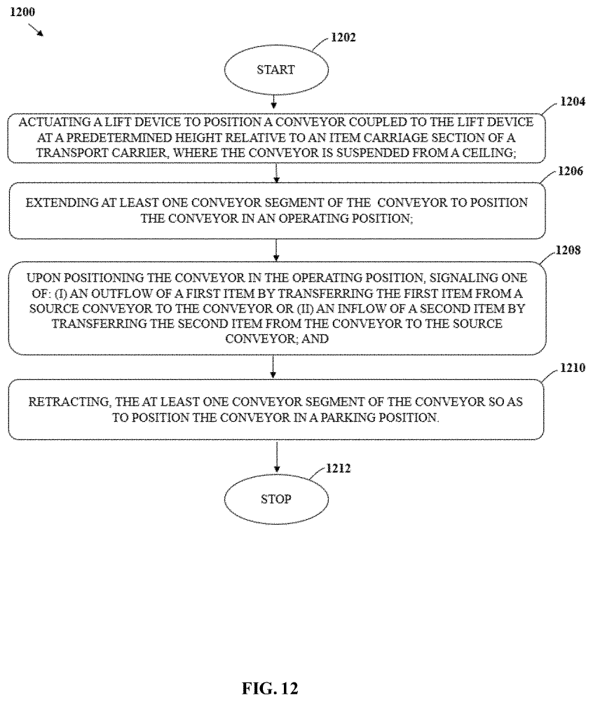

FIG. 12 schematically illustrates an example flowchart 1200 depicting operations performed by the item conveying apparatus 101, in accordance with some example embodiments described herein.

It will be understood that each block of the flowcharts, and combinations of blocks in the flowcharts, may be implemented by various means, such as hardware, firmware, one or more processors, circuitry and/or other devices associated with execution of software including one or more computer program instructions. For example, one or more of the procedures described above may be embodied by computer program instructions. In this regard, the computer program instructions which embody the procedures described above may be stored by a memory of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIG. 12 when executed, convert a computer or processing circuitry into a particular machine configured to perform an example embodiment of the present invention. Accordingly, the operations of FIG. 12 define an algorithm for configuring a computer or processor, to perform an example embodiment. In some cases, a general-purpose computer may be provided with an instance of the processor which performs the algorithm of FIG. 12 to transform the general-purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowchart, can be implemented by special purpose hardware-based computer systems which perform the specified functions, or combinations of special purpose hardware and computer instructions.

The method 1200 can start at step 1202. At step 1204, the item conveying apparatus 101 can include means, such as the control unit for actuating, the lift device 110 to position the conveyor 102 coupled to the lift device 110 at a pre-determined height relative to the item carriage section 708 of the transport carrier (i.e. the vehicle 710). As described earlier in reference to FIGS. 1-10, the conveyor 102 can be ceiling mounted, i.e. suspended from the ceiling 150 through the lift device 110. In an example, the height may be predetermined based on various factors, e.g. but not limited to, (a) a type of the vehicle 710 (i.e. based on a height of a platform of the transport carrier carrying one or more items), (b) a height of the ceiling 150 of the material handling environment, (c) floor plan or architecture of the material handling site etc. The conveyor 102 can be positioned at the predetermined height based on actuation of the actuator elements 111 of the lift device 110, in a similar manner, as described earlier in reference to FIGS. 1-10. In an example, the conveyor 102 can be positioned at the height H₂, as illustrated in FIG. 8, so as to interface the conveying surface of the conveyor 102 with the sectional floor surface 720 of the vehicle 710. In an example, the conveyor 102 can be positioned at the pre-determined height upon arrival of the transport carrier. i.e. the vehicle 710 at a defined location, i.e. an unloading/loading section of the material handling site.

Moving to step 1206 the item conveying apparatus 101 may include means, such as the control unit for extending at least one conveyor segment (e.g. from amongst the plurality of conveyor segments 103, 104, and 105) of the conveyor 102 to position the conveyor 102 in the operating position. The operating position referred herein, may correspond to the first state of the item conveying apparatus 101, as described earlier in reference to FIG. 1.

Upon positioning the conveyor 102 in the operating position, at step 1208, the item conveying apparatus 101 may include means, such as the control unit for signaling an inflow or outflow of one or more items through the conveyor 102. In this regard, in an example, the control unit may signal an outflow of a first item by transferring the first item from the source conveyor 106 to the conveyor 102. In an example, the first item may be further transported into the item carriage section 708 of the vehicle 710. Further, in another example, the control unit may signal an inflow of a second item by transferring the second item from the conveyor 102 to the source conveyor 106. In this regard, in an example, the second item may be received on the conveyor 102 from the vehicle 710 and can be transported to a storage location of the material handling environment by the source conveyor 106.

Moving to step 1210, the item conveying apparatus 101 may include means, such as the control unit to cause retracting of the at least one conveyor segment (e.g. from amongst the plurality of conveyor segments 103, 104, and 105) of the conveyor 102. In an example, the at least one conveyor segment may be retracted or pulled back so as to position the conveyor 102 in the parking position, in a similar manner, as described earlier in reference to FIGS. 3 and 6. In another example, the at least one conveyor segment may be retracted or pulled back so as to position the conveyor 102 in the retracted position, as described earlier in reference to FIGS. 2 and 5. The method 1200 stops at step 1212.

In an example embodiment, upon positioning the conveyor 102 at the pre-determined height, the method 1200 may also include interfacing the sectional floor unit 706 of the item handling unit 702 with the item carriage section 708 of the vehicle 710 i.e. the transport carrier. Interfacing of the sectional floor unit 706 with the item carriage section 708 of the vehicle 710 may be performed to initiate automated loading and/or unloading of items from the conveyor 102 to the vehicle 710 and vice versa, in a similar manner, as described earlier in reference to FIGS. 7-10. Further, the method 1200 may also include receiving the sectional floor surface 720 of the item carriage section 708 of the transport carrier into the sectional floor garage 718 defined beneath the conveyor 102. In this regard, the sectional floor surface 720 may be moved into the sectional floor garage 718 to unload the stack of items 728 from the vehicle 710 onto the conveyor 102 of the item handling unit 702, as described earlier in reference to FIGS. 7-10.

In accordance with some example embodiments described herein, ceiling-based installation of the item conveying apparatus 101 may include two individual belt conveyors, i.e. the conveyor 102 and a feed conveyor (i.e. the source conveyor 106) that can be installed side by side to each other. In some examples, the conveyor 102 can correspond to a telescopic boom conveyor where a telescopic function of the conveyor 102 can be generated by a moving transfer position for an item flow between individual belt conveyors, i.e. the two conveyors positioned side by side. In this regard, the conveyor 102 can be supported by a ceiling mounted lifting device e.g. the lift device 110.

In an example operation, upon arrival of transport carriers, such as trucks, at a distribution center, items can be unloaded. In this regard, using the item conveying apparatus 101, as described in accordance with various example embodiments herein, these items can be unloaded. To this end, the items can be unloaded on the conveyor 102 from the transport carriers and can be further sorted for delivery to customers/retailers. Further, the transport carriers can be reloaded via the item conveying apparatus 101 with other set of items for transportation. In this aspect, the items can be are generally loaded and/or unloaded from the conveyor 102 by extending the plurality of conveyor segments 103, 104, and 105 of the conveyor 102 and raising/lowering down the conveyor 102 at a desired height relative to the ground surface, as in required. In some example embodiments, an item from a carrier accumulation zone of the transport carrier may be transferred by hand onto the conveyor 102, which can thereafter convey the item into a distribution center via either a travelling conveyor belt or a set of rotating rollers positioned aside to the conveyor 102.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The control unit referred herein may include hardware used to implement the various illustrative logics, logical blocks, modules, and circuits described in connection with the aspects disclosed herein. It may include a general-purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods may be performed by circuitry that is specific to a given function.

In one or more example embodiments, the functions described herein may be implemented by special-purpose hardware or a combination of hardware programmed by firmware or other software. In implementations relying on firmware or other software, the functions may be performed as a result of execution of one or more instructions stored on one or more non-transitory computer-readable media and/or one or more non-transitory processor-readable media. These instructions may be embodied by one or more processor-executable software modules that reside on the one or more non-transitory computer-readable or processor-readable storage media. Non-transitory computer-readable or processor-readable storage media may in this regard comprise any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media may be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

1. An item conveying apparatus comprising:
a lift device suspended from a ceiling;
a conveyor at least partially engaged with the lift device, wherein the lift device is configured to manipulate a positioning of the conveyor, the conveyor comprising:
a conveyor frame;
a plurality of conveyor segments defining a conveying surface for an item,
wherein each conveyor segment of the plurality of conveyor segments is movable relative to the conveyor frame, wherein at least one conveyor segment of the plurality of the conveyor segments, upon receiving a command from a control unit, is adapted to:
extend, outwards from the conveyor frame to move the conveyor into an operational position; and
retract, inwards within the conveyor frame to move the conveyor into a parking position.

2. The item conveying apparatus of claim 1, wherein the lift device is an inverted scissor lift.

3. The item conveying apparatus of claim 2, wherein the lift device comprises at least two actuator elements, adapted to:
lower an actuation platform of the lift device to lower a height of the conveyor relative to a ground plane, wherein the actuation platform is coupled to the at least one conveyor segment of the conveyor; or
raise the actuation platform of the lift device to raise the height of the conveyor relative to the ground plane.

4. The item conveying apparatus of claim 1, wherein the conveyor is a roller conveyor defined between two side rails of the conveyor frame.

5. The item conveying apparatus of claim 1, wherein the conveyor comprises a plurality of drive wheel assemblies positioned within side rails defined by the conveyor frame, and wherein the drive wheel assemblies are adapted to move the at least one conveyor segment of the plurality of conveyor segments relative to the conveyor frame.

6. The item conveying apparatus of claim 1, wherein the conveyor is adapted to be moved to one of: the parking position, a retracted position, and the operational position, wherein:
in the operational position, the plurality of conveyor segments of the conveyor are extended outwards from the conveyor frame;
in the retracted position, the plurality of conveyor segments of the conveyor are partially retracted within the conveyor frame; and
in the parking position, the plurality of conveyor segments of the conveyor are at least partially retracted within the conveyor frame and the conveyor is raised up, by the lift device, towards the ceiling at a parking height.

7. The item conveying apparatus of claim 1, wherein the conveyor is installed above an in-feed conveyor of a material handling environment and wherein one end of the conveyor extends to define an inclined path adapted to drop a first item from the conveyor onto a first conveying surface of the in-feed conveyor.

8. The item conveying apparatus of claim 1, wherein the conveyor is installed below an out-feed conveyor and wherein one end of the out-feed conveyor extends to define an inclined path adapted to, drop a second item from a second conveying surface of the out-feed conveyor onto the conveyor.

9. The item conveying apparatus of claim 1, wherein the conveyor is installed aside of a feed conveyor, and wherein each of the conveyor and the feed conveyor includes a first side deflector and a second side deflector respectively and wherein the first side deflector and the second side deflector are adapted to:
deflect an incoming third item from the feed conveyor to the conveyor; and
deflect an incoming fourth item from the conveyor to the feed conveyor.

10. The item conveying apparatus of claim 1, wherein the conveyor is coupled to an item handling unit comprising:
an item transfer section, wherein at least a portion of the item transfer section is engaged to the lift device; and
a sectional floor unit coupled to the item transfer section, the sectional floor unit configured to interface with an item carriage section of a vehicle, the sectional floor unit comprising:
a transfer flap coupled to an end of the conveyor, the transfer flap configured to interface with a portion of the item carriage section of the vehicle; and
a sectional floor garage defined beneath the conveyor, the sectional floor garage configured to receive a sectional floor surface of the vehicle.

11. The item conveying apparatus of claim 10, wherein the sectional floor unit of the item handling unit is coupled to the item carriage section of the vehicle based on an interfacing of the transfer flap with the portion of the item carriage section and a connection of a first drive cable of the sectional floor unit to a second drive cable of the item carriage section, wherein at least one of the first drive cable and the second drive cable is configured to slidably pull the sectional floor surface of the vehicle into the sectional floor garage.

12. A system comprising:
a conveyor suspended from a ceiling, the conveyor comprising:
a conveyor frame;
a plurality of conveyor segments movable relative to the conveyor frame, the plurality of conveyor segments defining a conveying surface for an item, wherein at least one conveyor segment of the plurality of the conveyor segments, upon receiving a command from a control unit, is adapted to:
extend outwards from the conveyor frame; and
retract inwards within the conveyor frame.

13. The system of claim 12, further comprising a lift device suspended from the ceiling, wherein the conveyor is at least partially engaged with the lift device.

14. The system of claim 13, wherein the lift device is an inverted scissor lift.

15. The system of claim 13, wherein the lift device comprises at least two actuator elements, adapted to:
lower an actuation platform of the lift device to lower a height of the conveyor relative to a ground plane, wherein the actuation platform is coupled to the at least one conveyor segment of the conveyor; or
raise the actuation platform to raise the height of the conveyor relative to the ground plane.

16. The system of claim 12, wherein the conveyor is a roller conveyor defined between two side rails of the conveyor frame, and wherein the roller conveyor comprises a plurality of drive wheel assemblies positioned within side rails defined by the conveyor frame, and wherein the drive wheel assemblies are adapted to move the at least one conveyor segment of the plurality of conveyor segments relative to the conveyor frame.

17. The system of claim 13, wherein the conveyor is adapted to be moved to one of: a parking position, a retracted position, and an operational position, and wherein:
in the operational position, the plurality of conveyor segments of the conveyor are extended outwards from the conveyor frame;
in the retracted position, the plurality of conveyor segments of the conveyor are partially retracted within the conveyor frame; and
in the parking position, the plurality of conveyor segments of the conveyor are at least partially retracted within the conveyor frame and the conveyor is raised up, by the lift device, towards the ceiling at a parking height.

18. The system of claim 13, wherein the conveyor is coupled to an item handling unit comprising:
an item transfer section, wherein at least a portion of the item transfer section is engaged to the lift device; and
a sectional floor unit coupled to the item transfer section, the sectional floor unit configured to interface with an item carriage section of a vehicle, the sectional floor unit comprising:
a transfer flap coupled to the conveyor, the transfer flap configured to interface with a portion of the item carriage section of the vehicle; and
a sectional floor garage defined beneath the conveyor, the sectional floor garage configured to receive a sectional floor surface of the vehicle.

19. A method for handling items in a material handling environment, the method comprising:
actuating a lift device to position a conveyor coupled to the lift device at a predetermined height relative to an item carriage section of a transport carrier, wherein the conveyor is suspended from a ceiling;
extending at least one conveyor segment of the conveyor, outwards to position the conveyor in an operating position;
upon positioning the conveyor in the operating position, signaling one of: (i) an outflow of a first item by transferring the first item from a source conveyor to the conveyor or (ii) an inflow of a second item by transferring the second item from the conveyor to the source conveyor; and
retracting, the at least one conveyor segment of the conveyor, inwards so as to position the conveyor in a parking position.

20. The method of claim 19 wherein the conveyor is coupled to an item handling unit, and wherein the method further comprises:
interfacing a sectional floor unit of the item handling unit with the item carriage section of the transport carrier; and
receiving a sectional floor surface of the item carriage section of the transport carrier into a sectional floor garage defined beneath the conveyor to unload a plurality of items from the transport carrier onto the conveyor of the item handling unit.
